(19) United States
(12) Patent Application Publication
(10) Pub. No.: US 2008/0171213 A1
(43) Pub. Date: Jul. 17, 2008

(54) Use of Hydroxypropylated High Amylose Content Potato Starches to Achieve High Kit Numbers

(75) Inventors: Uwe Robben, Mannheim (DE); Thomas Luck, Neustadt (DE); Hermann Seyffer, Heidelberg (DE); Wolfgang Alois Hormuth, St. Martin (DE)

Correspondence Address: CONNOLLY BOVE LODGE & HUTZ, LLP, P O BOX 2207, WILMINGTON, DE, 19899, US

(73) Assignee: BASF Plant Science GmbH, Ludwigshafen (DE)

(21) Appl. No.: 10/593,989

(22) PCT Filed: Mar. 26, 2005
(86) PCT No.: PCT/EP2005/003220

§ 371 Date: Sep. 25, 2006

(30) Foreign Application Priority Data
Mar. 31, 2004 (DE) 102004016653.6

(51) Int. Cl. B32B 23/00

(52) U.S. Cl. 428/533; 428/532

(57) ABSTRACT

The invention relates to a process for the preparation of greaseproof packaging material with a kit number of greater than 21 by using hydroxypropylated high-amylose potato starch.

The invention relates to multilayer, greaseproof packaging materials with a substrate layer, consisting of paper/board and other suitable, polymer-based substances.

The invention further relates to a process for the preparation of greaseproof packaging material with a kit number of greater than 21 by using hydroxypropylated high-amylose potato starch with an amylose content of greater than 70%.

It has long been known to provide paper and board containers with coatings which have a barrier action for aromas or moisture/liquids. Thus, the patent application DE 41 09 983 A1 describes a flexible packaging container with a composite of a paper layer and a thermoplastic layer or film. The thermoplastic layer or film material consists of starch, a synthetic, non-polyolefinic, hydroxyl-containing polymer, for example an oxygenated polymer, and of plasticizers of natural origin, for example starch-derived polyalcohols. This material can be molten by exposure to heat and is therefore extrudable. The patent application DE 41 37 802 A1 proposes to laminate a board with a coated paper web in order to obtain a biodegradable product which is repellant to liquids. The coating of the paper web is to be starch-based. The patent application DE 42 94 110 discloses a coating dispersion which is made of copolymers of oxidized starch and styrene, butadiene, acrylic acid or similar polymerizable molecules. This dispersion reduces the permeability of paper or board for gases and water.

However, it is frequently necessary to provide packaging materials with high greaseproofness. Thus, animal feed, baked goods, confectionary and chocolate require that the packaging have a particularly high greaseproofness, which is indicated for example by the kit numbers with values of between 8 and 12. High kit numbers represent a high greaseproofness.

Suitable commercially available paper/board packagings have usually undergone a grease-repellant surface and/or bulk treatment. Currently, it is mainly fluoropolymers which are employed for such a bulk treatment or surface treatment, with approximately up to 5% by weight of coating material being applied to the material. A greaseproofness as low as >6 to 8 can only be achieved by combining layer and bulk treatments, while a greaseproofness with kit numbers >12 cannot be guaranteed with the current systems. For example, the packaging of dry animal feed with a low fat content (<10% ) requires a bulk treatment of the reverse side, while, in the case of higher fat contents, a barrier is effected by a bulk treatment in combination with a surface coating.

Paper, paperboard and cardboard packaging is properly disposed of via the waste paper cycle. Thus, the halopolymers employed as grease barriers end up either in the virgin paper product or in the process wastewater via the pulping process.

Starch ethers are known in the paper industry as adjuvants and starting materials. The properties which are exploited in the process are described in detail in the relevant literature. They are employed in the surface coating, in the sizing and in pigmented paper coatings. According to the BGVV (Bundesinstitut für gesundheitlichen Verbraucherschutz und Veterinärmedizin [German Federal Institute for Consumer's Health Protection and Veterinary Medicine]), even paper, cardboard and paperboard approved for food contact may contain starch ethers (for example hydroxyethyl and hydroxypropyl ethers). Furthermore, starch ethers are used as component in adhesives owing to their good film-forming properties and their water-binding capacity. In this context, literature can be found for example in Ullmanns Enzyklopädie der technischen Chemie [Ullmann's Encyclopedia of Technical Chemistry]; W. Baumann/B. Herberg: Papierchemikalien—Fakten zum Umweltschutz [Paper chemicals—ecologically relevant facts] (Springer-Verlag); O. B: Würzburg:

Modified Starches: Properties and Uses (CRC Press).

WO 02/02412 describes multi-layer packagings for greasy materials, based on native, modified starch.

It is furthermore known that starch ether derivatives can be processed to give foils or films, mainly from aqueous solution using casting technology.

When the starch ethers are prepared by the slurry method, the aqueous starch suspension is derivatized under alkaline conditions at temperatures of up to 50° C. The degree of derivatization is, in most cases, around 0.2. Characteristic of these methods is the preferred derivatization at the C2 atom. Another method, which is predominantly known from scientific studies (autoclave method), starts from alkaline-activated starch and arrives at more homogeneous derivatizations at lower dry matter concentrations, the degree of derivatization, however, being adjusted similarly. A procedure following this strategy is described in the patent application DE 42 23 471 A1, where the resulting starch ethers are to be employed for the preparation of foils, in particular for the use as overhead foils, acetates and printing foils or for the surface finishing of specialist papers and as packaging material. Moreover, this publication mentions that the abovementioned ether derivative foils can be used in combination with other materials.

It is an object of the present invention to provide greaseproof packaging materials which are admissible in accordance with food law and which have a very high kit number.

Surprisingly, it has now emerged that substrates which themselves are not sufficiently grease-resistant, such as paper, cardboard, paperboard or other materials made from or with cellulose, are greaseproof when they are coated with alkylene-oxide-derivatized starch with an amylose content of greater than 70%.

The present invention therefore provides multilayer packagings for greasy products or parts of such packagings, which packagings comprise a substrate layer of a polymeric material as the main component and at least one layer applied to the substrate layer, which does not form the exterior of the packaging, where the layer applied to the substrate layer comprises an alkylene-oxide-derivatized starch with an amylose content of greater than 70% as the main component. The alkylene oxide used for this purpose can suitably be a C₂-C₆-alkylene oxide. C₂-C₄-Alkylene oxides are preferred.

By coating a support material with the functional layer “high-amylose (HA) starch derivative”, a greaseproof composite system is realized. The HA starch component is responsible for the greaseproofness and has furthermore the characteristic of being biodegradable. Moreover, such a starch can be incorporated readily into coating compositions for the abovementioned purpose, since it—in contrast to native starch—is not susceptible to reaggregation (retrogradation).

The packagings of the present invention are not limited to specific embodiments. An exemplary, preferred field of application are packagings of foodstuffs and animal feeds which are low in water combined with being high in fat, in particular folding boxes. Examples are packagings for biscuits, chocolates, other sweets, dry animal feed, where a particularly good barrier against the penetration of water vapor is not required. However, packagings for fat-containing nonfoods (for example cosmetics, oily color pigments or the like) can also be embodied in accordance with the invention.

Further applications are the coating of polymers other than cellulose with the material proposed in accordance with the invention (for example other packaging plastics) for similar packaging requirements. Another possible use is the coating of paper intended as a wrapping paper.

The packaging materials of the present invention allow a high greaseproofness to be achieved which is in the range from a kit number of 10, preferably at least 17, but as a rule considerably higher. Thus, it is possible to achieve repellencies with a kit number of above 21, which cannot be guaranteed with the existing, nonbiologically compatible or nonbiodegradable systems.

Further advantages of the packagings according to the invention are that their production is compatible with usual methods of paper or cardboard making and that they are biodegradable; said packagings, in comparison with traditional systems, can be classified as being particularly advantageous with regard to economical and/or ecological evaluations, particularly when taking into consideration the factors of coating cost including process costs and the compatibility with the paper recycling process.

As the result of their biodegradability, the packagings coated in accordance with the invention ensure a good compatibility with the processing facilities and the wastewater purification facilities of wastepaper disposal plants. In this respect, the degradation behavior in the paper cycle represents a decisive advantage in the sense of avoiding the introduction of additional interfering substances. Suitable materials for the substrate layer are, in particular, paper, paperboard or cardboard, if appropriate in mixture with other suitable substances, or substances which are conventionally used or admissible in food packaging technology, such as binders or colorants. However, other materials, preferably materials which are based on natural polymers such as cellulose and the like, or plastics, can also be employed.

HA starch derivatives which are suitable in accordance with the invention are those which have been derivatized with an alkylene oxide such as ethylene oxide or propylene oxide or a longer-chain alkylene oxide. The attached groups enlarge the distances between the molecular chains and thus increase their mobility. The internal plasticizing effect thus provided can only be reversed by destroying the chemical bond.

The HA starch derivative should preferably form a continuous film on the substrate layer. If this is the case, even very thin layers from a gsm substance of approximately 6 g/m² can be greaseproof, providing the support material is relatively smooth.

The coating can be provided as a surface layer on the inner side of the packaging and/or as an intermediate layer, if appropriate also having the function of an adhesive layer between paper and cardboard layers or the like. Several coatings applied one directly onto the other can also be advantageous. Likewise, what is known as a prime-coating (for example with customary paper coating substances like kaolin or starch) can be applied prior to the coating with the HA starch derivative, said prime-coating having the purpose of pre-smoothing the surface. In this manner, gsm substances for achieving a defect-free layer may, if appropriate, be reduced in this manner.

If appropriate, the HA-starch-derivative-comprising layer can be placed onto the substrate layer by applying a self-supporting layer made of this material. Preferably, however, a solution or suspension of the HA starch derivative is prepared, using a suitable quantity of dry matter, and applied to the support material, preferably, it is made of an aqueous solution or suspension. A suitable amount of dry matter (DM) of the HA starch derivative is in the range of from approximately 5 to approximately 50% by weight, preferably in the range of from approximately 10 to approximately 40% by weight, the amount actually to be selected depending on the application method intended. Thus, in some cases, a quantity of as little as 4% by weight may be sufficient.

The application can be effected for example using a blade, by spraying or by roller application, also by “pressure casting” a more concentrated solution, and by surface-application of a thermo-plasticized melt (“extrusion”). In all cases, the water content of the HA starch derivative after the application on the support material should be reduced to approximately <25% by weight (for example by drying by IR or by convection drying).

Besides the HA starch derivative, the layer to be applied onto the substrate layer may also comprise further additives. Firstly, the addition of pigments (as generally customary in paper industry) offers itself; secondly, glycerol, urea, borax, glyoxal or other additives with similar properties and effects can be added in order to achieve desired values regarding elasticity, water resistance and long-term stability. In some cases, it is also possible to exert a positive effect on the kit number by adding such substances, for example, by addition of glycerol or crosslinker (for example glyoxal). However, the proportion of high-amylose starch derivative should preferably still be sufficiently high for ensuring that a defect-free film is formed.

The starting material used is preferably potato starch with an amylose content of greater than 70%. A potato starch with an amylose content of over 70% can be isolated for example from genetically modified potato plants in which the enzymatic activity of the starch branching enzymes SBE I and II is reduced in comparison with the non-genetically-modified starting plant. A method for generating such plants is described by way of example in example 1. Further descriptions for the generation of genetically modified potato plants with an amylose content of greater than 70% are described in the patent applications WO 92/11375, WO 97/20040, WO 92/14827, WO 95/26407 and WO 96/34968 and the patents U.S. Pat. No. 5,856,467, U.S. Pat. No. 6,169,226, U.S. Pat. No. 6,469,231, U.S. Pat. No. 6,215,042, U.S. Pat. No. 6,570,066 and U.S. Pat. No. 6,103,893.

Alternatively, potato plants with a reduced enzymatic activity of the starch branching enzymes SBE I and SBE II can also be obtained by selecting suitably mutagenized potato plants.

Other starting materials which can be employed are starches with an amylose content of greater than 70% which are derived from other crop plants such as, for example maize, wheat, peas or tapioca. Plants with an amylose content of greater than 70% can be generated by genetic modification using molecular-biological methods, and/or by breeding and selection.

HA starch is understood as meaning a starch with an amylose content of at least 70%. Preferably, the amylose content amounts to at least 80%, especially preferably at least 90%.

The potato starch with an amylose content of greater than 70% is modified chemically for example with a C₂- or C₃-alkylene oxide. Propylene oxide is preferred.

Since the HA starch is suitably modified in the presence of a base, but the composition provided for the coating should advantageously have an approximately neutral reaction so that normally a neutralization with acid must be effected, the modified HA starch is, as a rule, highly contaminated with salts. It is advantageous if this salt content is not too high. It is therefore recommended that the coating composition in the concentration provided for the application should have a conductivity of not more than 4000-5000 pS/cm, preferably <2000 pS/cm.

The addition of acids and lyes should be effected taking into consideration that the salt formed be safe with regard to food law. Suitable acids are phosphoric acids, a suitable base is sodium hydroxide solution. The desalination can be effected for example by dialysis.

Coatings with higher-derivatized HA starch present more favorable kit numbers than those with lower degrees of derivatization. However, it is not necessary to achieve high substitution rates, since already low rates can have positive effects. These are moreover dependent on the origin of the HA starch used. While, quite generally, a degree of derivatization of from 0.05 to 1.5 can be suitable, ranges of between 0.1 and 1.0, very specially preferably between 0.1 and 0.3, re preferred.

The preparation of an HA starch ether solution which is suitable as a coating composition or a casting solution for the present invention can be accomplished for example as follows: the starch with an amylose content of greater than 70% (for example wheat, maize, tapioca, potato or HA-pea starch) is stirred for several hours in approximately twice its own weight of water and subsequently a large portion of the water is removed, for example by suction-drying. During this process, the starch absorbs approximately its own weight of water so that it has a dry matter content of approximately 40 to 60%. It is then resuspended in approximately 1.5 times its wet weight and disintegrated by addition of the same quantity of an approximately 10% strength base or lye. Immediately thereafter, approximately 25-75% by weight of alkylene oxide, preferably propylene oxide, based on the starting weight of the dry HA starch, are added in the course of a few minutes to up to approximately 1 hour, during which process mild temperature conditions should be maintained. Room temperature is suitable. The mixture is stirred for several hours and then left to stand for approximately 20 hours; it is subsequently neutralized with acid. If a desalination is to be carried out, this is accomplished for example by dialysis against water. The desalinated solution is concentrated under mild conditions, if appropriate. The degree of derivatization of the HA starch is approximately 0.2 if approximately 50% by weight of propylene oxide is used; in other cases it is correspondingly higher or lower.

A desalination or removal of interfering inhomogeneities can also be effected for example by ultrafiltration. If the product is too highly concentrated, it may be diluted with deionized water.

After any desired additives (for example preservatives, fillers, antistatic agents, elasticity-improving agents, crosslinking agents) have been added, a mechanical separation using filters or a centrifuge can be effected, if required, which simultaneously will result in a degasification of the solution to be processed.

A coating solution which is particularly suitable for the purposes of the invention has the following rheological properties:

a dynamic viscosity of from 0.1 Pas to 40 Pas at a temperature of 25° C. and a shear rate of 30.7 s⁻¹. Viscoelastic properties of the polymer solution, the ratio of viscous to elastic proportion, having Tan K values of between 1 and 10 (50 at maximum) at a temperature of 25° C. and a shear rate of 30.7 s⁻¹. Such values can be obtained without difficulties when using the method mentioned by way of example.

Another advantage which the process offers is the fact that the HA starch is reacted and processed under particularly mild conditions and, in particular, throughout at relatively low temperatures (<60° C.), which has positive effects on the coating of the support material. As the result of the solubility in cold water following neutralization, separation, salt removal and concentration, the starch with an amylose content of 70% can be processed under such mild conditions that only insignificant degradation reactions, if any, occur.

The aqueous casting solution can be applied to the material web (paper) to be coated preferably at room temperature or slightly elevated temperature, using a suitable application system (for example a blade).

The use of hydroxypropyl ether starches prepared by the autoclave method, in particular from potato starch with an amylose content of greater than 70%, which are employed as solutions with dry matter contents of from 12 to 20% by weight and preferably with degrees of derivatization (DS) of from 0.1 to 1.0, more preferably up to 0.4, has proved to be particularly favorable. These starches exhibit a markedly better greaseproofness in comparison with commercial samples (coated with fluorocarboxylic acids), in particular also in areas of folding, which are particularly critical when the material is used for folding boxes. In comparison with the abovementioned coatings according to the invention with commercially available starch derivatives, it is possible to reduce the gsm substances for the coating with such starches.

### EXAMPLE 1

### Generation of Transgenic Potato Plants with a High Amylose Content

Potato plants with an amylose content of greater than 70% can be generated using the antisense or the RNAi technology with the purpose of reducing, or eliminating, the enzymatic activity of the starch branching enzymes SBE I and SBE II.

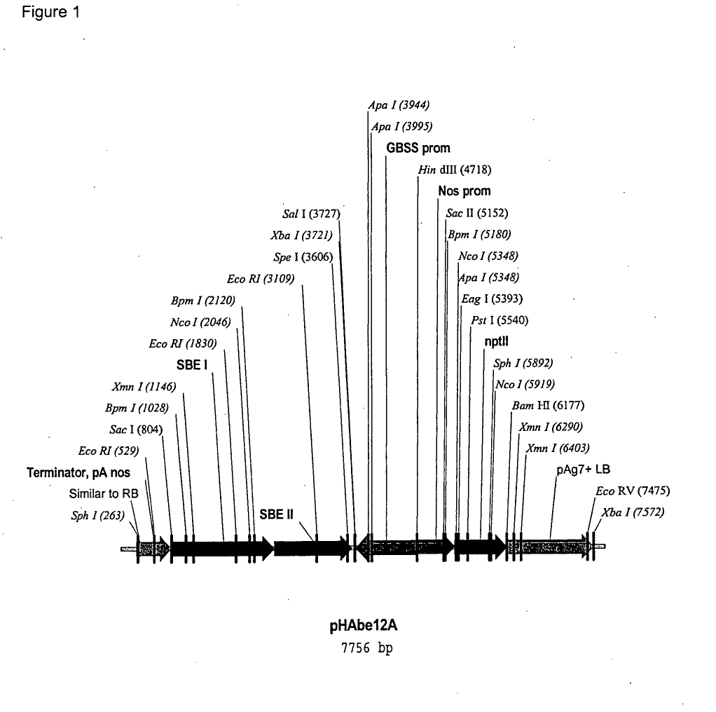

For example, the HA-starch-producing transgenic potato line Solanum tuberosum AM99-2003 was generated, in which the activity of the starch branching enzymes is inhibited. The genetic transformation of the starting variety Dinamo was carried out using a gene construct which comprises gene fragments under the control of a GBSS promoter of SBE I and SBE II in antisense orientation. PBluescript comprising a 1620 bp fragment of the 3′-end of the SBE I gene between EcoRV and Spel is cleaved with Spel and Xbal and ligated with a 1243 bp Sstl-Xbal fragment of the 3′-end of SBE II. The SBE I complex and the SBE 2 complex are excised with the aid of EcoRV and Xbal and ligated into the binary vector pHo3.1 which has been opened with Smal and Xbal. The resulting vector is named pHabe12A, see FIG. 1 and nucleic acid sequence SEQ-ID No. 1.

PHo3.1 is based on pGPTVKan (Becker, D. et al., Plant Molecular Biology 20 (1992), 1195-1197) and additionally comprises the GBSS promoter 987 bp (see EP 0 563 189), which was cloned into the HindIII site of pGPTVKan and whose uidA gene has been removed with the aid of Smal and Sstl.

The parent line Dinamo is transformed with the construct pHAbe12A by the method described in U.S. Pat. No. 6,169,226, and the transgenic lines are selected on kanamycin-comprising media. The amylose content of the transgenic plants is analyzed by the method described in (Morrison, W. R. and Laignelet, B., J. Cereal. Sci. 1 (1983), 9-20).

Transgenic potato plants with an amylose content of at least 70% were selected and grown. The high-amylose starch was isolated by customary methods.

### EXAMPLE 2

### Hydroxypropylation of High-Amylose Potato Starch

High-amylose potato starch obtained from genetically modified potato plants—see example 1—was hydroxypropylated on a laboratory scale. The potato starch with an amylose content of 70% was modified in accordance with an autoclave or homogeneous method.

After the hydroxypropylation reaction, the solution was processed by desalinification and concentration in order to be used for coating cardboard at a later point in time. The final product should have a degree of derivatization of approximately 0.2, a dry matter content (w/w) of approximately 18% and a conductivity of approximately 600 μS/cm.

For the cardboard-coating experiments, a variety of application weights were created with the hydroxypropylated HA starch by means of manual application with a blade.

To coat the cardboard (by Cupforma) the HA starch was heated to 40° C. The HA starch solution was applied (once or twice, respectively) to the sized and unsized side of the cardboard.

### EXAMPLE 3

### Characterization of the End Product

Starting with 713 g of HA starch from potato plants with an amylose content of 70% —prepared by the method described in example 1—1770 g of hydroxypropyl-HA-starch with a dry weight of 27 (w/w) % and a conductivity of 880 μS/cm was prepared. Reduction of the conductivity by diafiltration was not possible.

### EXAMPLE 4

### Testing the Greaseproofness with the 3M Kit Test

To test the coating for resistance to nonpolar substances, it is tested for fastness to mixtures with 2-liter test solutions with various concentrations of castor oil, toluene and n-heptane. The kit solution with the highest number which sits on the sample for 15 seconds without causing wetting or discoloration is the characterizing kit number.

Cardboard from Cupforma was used.

The results are compiled in the table.

| | Application weight in | |
|---|---|---|
| Coating in μm | g/m² | Kit test |
| 12 | 52.7 | >21 |
| 24 | 12.1 | >21 |
| 24 × 2 | 44.6 | >21 |

In all three cases, the coating, which had a kit number of >21, proved to be greaseproof as per 3M kit test.

### EXAMPLE 5

713 g of potato starch with an amylose content of 70% are stirred for 4 hours in 1.3 l distilled water and then suction-filtered. The moist starch is stirred with 1.824 l of water and treated with 1.811 g of 10% strength sodium hydroxide solution, obtained by mixing 376 g of 50% strength NaOH with 1.505 g of water. The derivatization is accomplished with 323 g of propylene oxide at 23° C., which is added with stirring in the course of 20 minutes. Stirring of the mixture is continued for 4 hours and the mixture is then left to stand for 20 hours. It is neutralized with 40% strength phosphoric acid (approximately 700 g). Thereafter, the solution is filled into dialysis tubes and dialyzed for approximately 4 days, with daily water changes. The product is concentrated to over 20% dry matter with the aid of a vacuum rotary evaporator.

The resulting HA starch ether has a degree of derivatization of approximately 0.2. The conductivity of the coating composition is approximately 1100 pS/cm.

Analogously to this example, the following coating compositions are prepared and applied to one-sidedly coated Chromo Duplex cardboard (GD2), 310 g/m², thickness approximately 420 μm, using a 20-μm blade. After the first coating has dried (finger-dry, duration approximately 2 hours), a second coating is applied and dried at room temperature at approximately 50% atmospheric humidity for about 1 week or longer, if desired.

The coated mass is determined by weighing three cardboard sheets of the coated samples (proceeding as specified in DIN 53 104: Prüfung von Papier und Pappe, Bestimmung des Flächengewichts [Testing paper and paperboard, determination of the gsm substance], September 1971) and the thickness is determined using a caliper gauge (caliper: even/bulged, 30 SKT, MB=1 μm). In addition, the kit number for unpolar substances is determined by the 3M kit test. The test fluids used are solvent mixtures of castor oil, toluene and heptane. The kit solution with the highest number which sits on the sample for 15 seconds without bringing about wetting or discoloration is the characterizing kit number.

1. A multilayer packaging for greasy products or part of such a packaging, comprising
a substrate layer of a polymeric material as the main component and
at least one layer applied to the substrate layer, which does not form the exterior of the packaging, and which comprises a high-amylose starch derivative with an amylose content of at least 70% as the main component, wherein the high-amylose starch derivative is a C₂-C₆-alkylene-oxide-modified starch derivative.

2. The multilayer packaging according to claim 1, wherein the high-amylose starch derivative is a C₂-C₄-alkylene-oxide-modified starch derivative.

3. The multilayer packaging or part of such a packaging according to claim 1, wherein the C₂-C₆-alkylene oxide is propylene oxide.

4. The multilayer packaging or part of such a packaging according to claim 1, wherein the high-amylose starch derivative is obtained by modifying partially degraded maize, wheat, potato, HA-pea or tapioca starch.

5. The multilayer packaging or part of such a packaging according to claim 1, wherein the degree of derivatization of the starch derivative amounts to 0. 1 to 1.

6. The multilayer packaging or part of such a packaging according to claim 1, wherein the polymeric material of the substrate layer is a naturally occurring polymer.

7. The multilayer packaging or part of such a packaging according to claim 1, wherein the layer comprising the high-amylose starch derivative as main component comprises additional constituents selected from the group consisting of pigments, plasticizers, agents which improve the long-term stability, agents which improve the water resistance and agents which influence the elasticity.

8. A process for producing a multilayer packaging with grease-resistant properties comprising applying a layer of a C₂-C₆-alkylene-oxide-derivatized high-amylose starch as main component to a substrate layer of the multilayer packaging, wherein the substrate layer is made of a polymeric material.

9. The process according to claim 8, wherein the C₂-C₆-alkylene oxide is propylene oxide.

10. The process according to claim 8, wherein the starch derivative is obtained by modifying high-amylose potato starch.

11. The process according claim 10, wherein a high-amylose potato starch with an amylose content of at least 70% is used for the modification.

12. The use process according to claim 8, wherein the layer comprising the high-amylose starch derivative as main component comprises additional components selected from the group consisting of pigments, plasticizers, agents which improve the long-term stability, agents which improve the water resistance, agents which improve the kit number and agents which influence the elasticity, preferably selected among glycerol, urea, borax or glyoxal.

13. The multilayer packaging or part of such a packaging according to claim 1, wherein the degree of derivatization of the starch derivative amounts to 0.1 to 0.4.

14. The multilayer packaging or part of such a packaging according to claim 1, wherein the polymeric material of the substrate layer is a naturally occurring cellulose.

15. The process according to claim 8, wherein the starch derivative has a degree of derivatization of from 0.1 to 1.

16. The process according to claim 8, wherein the starch derivative has a degree of derivatization of from 0.1 to 0.4.


SEQUENCE LISTING (1 sequence)

SEQ ID NO: 1 - DNA, 15294 bp, Artificial sequence
  Description of the artificial sequence vector pHAbe12A
ggccgggagggttcgagaagggggggcaccccccttcggcgtgcgcggtcacgcgcacagggcgcagccctggttaaaaacaaggtttataaatattggtttaaaagcaggttaaaagacaggttagcggtggccgaaaaacgggcggaaacccttgcaaatgctggattttctgcctgtggacagcccctcaaatgtcaataggtgcgcccctcatctgtcagcactctgcccctcaagtgtcaaggatcgcgcccctcatctgtcagtagtcgcgcccctcaagtgtcaataccgcagggcacttatccccaggcttgtccacatcatctgtgggaaactcgcgtaaaatcaggcgttttcgccgatttgcgaggctggccagctccacgtcgccggccgaaatcgagcctgcccctcatctgtcaacgccgcgccgggtgagtcggcccctcaagtgtcaacgtccgcccctcatctgtcagtgagggccaagttttccgcgaggtatccacaacgccggcggccgcggtgtctcgcacacggcttcgacggcgtttctggcgcgtttgcagggccatagacggccgccagcccagcggcgagggcaaccagcccggtgagcgtcgcaaaggcgctcggtcttgccttgctcgtcggtgatgtacttcaccagctccgcgaagtcgctcttcttgatggagcgcatggggacgtgcttggcaatcacgcgcaccccccggccgttttagcggctaaaaaagtcatggctctgccctcgggcggaccacgcccatcatgaccttgccaagctcgtcctgcttctcttcgatcttcgccagcagggcgaggatcgtggcatcaccgaaccgcgccgtgcgcgggtcgtcggtgagccagagtttcagcaggccgcccaggcggcccaggtcgccattgatgcgggccagctcgcggacgtgctcatagtccacgacgcccgtgattttgtagccctggccgacggccagcaggtaggccgacaggctcatgccggccgccgccgccttttcctcaatcgctcttcgttcgtctggaaggcagtacaccttgataggtgggctgcccttcctggttggcttggtttcatcagccatccgcttgccctcatctgttacgccggcggtagccggccagcctcgcagagcaggattcccgttgagcaccgccaggtgcgaataagggacagtgaagaaggaacacccgctcgcgggtgggcctacttcacctatcctgcccggctgacgccgttggatacaccaaggaaagtctacacgaaccctttggcaaaatcctgtatatcgtgcgaaaaaggatggatataccgaaaaaatcgctataatgaccccgaagcagggttatgcagcggaaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgccagaaggccgccagagaggccgagcgcggccgtgaggcttggacgctagggcagggcatgaaaaagcccgtagcgggctgctacgggcgtctgacgcggtggaaagggggaggggatgttgtctacatggctctgctgtagtgagtgggttgcgctccggcagcggtcctgatcaatcgtcaccctttctcggtccttcaacgttcctgacaacgagcctccttttcgccaatccatcgacaatcaccgcgagtccctgctcgaacgctgcgtccggaccggcttcgtcgaaggcgtctatcgcggcccgcaacagcggcgagagcggagcctgttcaacggtgccgccgcgctcgccggcatcgctgtcgccggcctgctcctcaagcacggccccaacagtgaagtagctgattgtcatcagcgcattgacggcgtccccggccgaaaaacccgcctcgcagaggaagcgaagctgcgcgtcggccgtttccatctgcggtgcgcccggtcgcgtgccggcatggatgcgcgcgccatcgcggtaggcgagcagcgcctgcctgaagctgcgggcattcccgatcagaaatgagcgccagtcgtcgtcggctctcggcaccgaatgcgtatgattctccgccagcatggcttcggccagtgcgtcgagcagcgcccgcttgttcctgaagtgccagtaaagcgccggctgctgaacccccaaccgttccgccagtttgcgtgtcgtcagaccgtctacgccgacctcgttcaacaggtccagggcggcacggatcactgtattcggctgcaactttgtcatgcttgacactttatcactgataaacataatatgtccaccaacttatcagtgataaagaatccgcgcgttcaatcggaccagcggaggctggtccggaggccagacgtgaaacccaacatacccctgatcgtaattctgagcactgtcgcgctcgacgctgtcggcatcggcctgattatgccggtgctgccgggcctcctgcgcgatctggttcactcgaacgacgtcaccgcccactatggcattctgctggcgctgtatgcgttggtgcaatttgcctgcgcacctgtgctgggcgcgctgtcggatcgtttcgggcggcggccaatcttgctcgtctcgctggccggcgccaagatctggggaaccctgtggttggcatgcacatacaaatggacgaacggataaaccttttcacgcccttttaaatatccgattattctaataaacgctcttttctcttaggtttacccgccaatatatcctgtcaaacactgatagtttaaactgaaggcgggaaacgacaatctgatcatgagcggagaattaagggagtcacgttatgacccccgccgatgacgcgggacaagccgttttacgtttggaactgacagaaccgcaacgttgaaggagccactcagccgatctgaattcccgatctagtaacatagatgacaccgcgcgcgataatttatcctagtttgcgcgctatattttgttttctatcgcgtattaaatgtataattgcgggactctaatcataaaaacccatctcataaataacgtcatgcattacatgttaattattacatgcttaacgtaattcaacagaaattatatgataatcatcgcaagaccggcaacaggattcaatcttaagaaactttattgccaaatgtttgaacgatcggggaaattcgagctcggtaccatcatgttacaaacttttttgctgtgagcagtagatatggaaacccggaggacctaaagtatctgatagataaagcacatagcttgggtttacaggttctggtggatgtagttcacagtcatgcaagcaataatgccactgatggcctcaatggctttgatattggccaaggttctcaagaatcctactttcatgctggagagcaagggtaccataagttgtgggatagcaggctgttcaactatgccaattgggaggttcttcgtttccttctttccaacttgaggtggtggctagaagagtataactttgacggatttcgatttgatggaataacttctatgctgtatgttcatcatggaatcaatatgggatttacaggaaactataatgagtatttcagcgaggctacagatgttgatgctgtggtctatttaatgttggccaataatctgattcacaagattttcccagacgcaactgttattgccgaagatgtttctggtatgccgggccttggccggcctgtttctgagggaggaattggttttgattaccgcctggcaatggcaatcccagataagtggatagattatttaaagaataaaaatgatgaagattggtccatgaaggaagtaacatcgagtttgacaaataggagatatacagagaagtgtatagcatatgcggagagccatgatcagtctattgtcggtgacaagaccattgcatttctcctaatggacaaagagatgtattctggcatgtcttgcttgacagatgcttctcctgttattgatcgaggaattgcgcttcacaagatgatccattttttcacaatggccttgggaggagaggggtacctcaatttcatgggtaacgagtttggccatcctgagtggattgacttccctagagagggcaataattggtgttatgacaaatgtagacgccagtggaaccttgcggatagcgaacacttgagatacaagtttatgaatgcatttgatagagctatgaattcgctcgatgaaaagttctcattcctcgcatcaggaaaacagatagtaagcagcatggatgatgagaagaaggttgttgtgtttgaacgtggtgacctggtatttgtattcaacttccacccaaataacacatacgaagggtataaagttggatgtgacttgccagggaagtacagagttgcactggacagtgatgcttgggaatttggtggccatggaagagctggtcatgatgttgaccatttcacatcaccagaaggaatacctggagttccagaaacaaatttcaatggtcgtccaaattccttcaaagtgctgtctcctgcgcgaacatgtgtggcttattacagagttgacgaacgcatgtcagaaactgaagtttaccagacagacatttctagtgagctactaccaacagccaatatcgaggagagtgacgagaaacttaaagattcgttatctacaaatatcagtaacgttgacgaactcatgtcagaaactgaagtttaccagacagacatttctagtgagctactaccaacagccagtatcgaggagagtgacgagaaacttaaagattcattatctacaaatatcagtacgtggttatcattggatgtgggattcccgcctctttaattatggaaactgggaggtacttaggtatcttctctcaaatgcgagatggtggttggatgagttcaaatttgatggatttagattcgatggtgtgacatcaataatgtatactcaccacggattatcggtgggattcactgggaactacaaggaatactttggactcgcaactgatgtggatgctgttgtgtatctgatgctggtcaacgatcttattcatgggcttttccagatgcaattaccattggtgaagatgttagcggaatgccgacattttgtattcccgttcaagatgggggtgttggctttgactatcggctgcatatggcaattgctgataaatggattgagttgctcaagaaacgggatgaggattggagagtgggtgatattgttcatacactgacaaatagaagatggtcggaaaagtgtgtttcatacgctgaaagtcatgatcaagctctagtcggtgataaaactatagcattctggctgatggacaaggatatgtatgattttatggctctggatagaccatcaacatcattaatagatcgtgggatagcattgcacaagatgattaggcttgtaactatgggattaggaggagaagggtacctaaatttcatgggaaatgaattcggccaccctgagtggattgatttccctagggctgaacaacacctctctgatggctcagtaattcccggaaaccaattcagttatgataaatgcagacggagatttgacctgggagatgcagaatatttaagataccgtgggttgcaagaatttgaccgggctatgcagtatcttgaagataaatatgagtttatgacttcagaacaccagttcatatcacgaaaggatgaaggagataggatgattgtatttgaaaaaggaaacctagtttttgtctttaattttcactggacaaaaagctattcagactatcgcataggctgcctgaagcctggaaaatacaaggttgccttggactcagatgatccactttttggtggcttcgggagaattgatcataatgccgaatatttcacctttgaaggatggtatgatgatcgtcctcgttcaattatggtgtatgcacctagtagaacagcagtggtctatgcactagtagacaaagaagaagaagaagaagaagaagtagcagtagtagaagaagtagtagtagaagaagaatgaacgaacttgtgatcgcgttgaaagatttgaaggctacatagctctagagtcgacctgcatgaaatcagaaataattggaggagatgagtaaaagttaccacttgttgagctgtgtgagtgagtgagtgagaatgaggaggtgcctgccttatttgtagcaggtttcagtgacacgtgtcaagagaatagcgggtggctatcccttagcagaaggcaactgtggacactgtattatagggaaatgctcatcgacagtattatgggccctctctttgttgattcacggctggacttcaacttgggccttgcaatgggcccgtccggttctgtctcctagtatctaaaaaactaaaccaactccctcctaccgctaccacttgacattcctatgtctcgtgttaattaaattattattatagtaattaaaaataatatctaggtactggtactggtccctccctccactagaatattagttacttcccccttagctttgtattccaaattactgtaaatatattttctaattttttacgacaaacaagatctaattatgaatgcacaattctaaaggttgaatacattactttacttggtttagcctatattaagttgcattttagtattaagattgagatgcatggttctattacaaaattgatacactgctaaaggaaggatggttaaaaacaacattcaatgtttgttacatttcttcctattgtattttttttttaacgagcttcccgtatacatcataacatgtctccgttccacttggcaggaaaaaaaaatacccaaacaggaagatactgtcaagtatatccatagatgaggacttaatggataggcttttcgaggattcataaatcataatatctggcggaggagtcaattaaatacttgtggtttgtatcctgattactccgtcaacagccaaatagaaaagtttgaaaagagagaaaggatttggtacaagatactgttgcatttgttaagtaatgaacaaaacggagtaacataattttctatctcgttaaagcttcacgctgccgcaagcactcagggcgcaagggctgctaaggaagcggaacacgtagaaagccagtccgcagaaacggtgctgaccccggatgaatgtcagctactgggctatctggacaagggaaaacgcaagcgcaaagagaaagcaggtagcttgcagtgggcttacatggcgatagctagactgggcggttttatggacagcaagcgaaccggaattgccagctggggcgccctctggtaaggttgggaagccctgcaaagtaaactggatggctttcttgccgccaaggatctgatggcgcaggggatcaagatcatgagcggagaattaagggagtcacgttatgacccccgccgatgacgcgggacaagccgttttacgtttggaactgacagaaccgcaacgttgaaggagccactcagccgcgggtttctggagtttaatgagctaagcacatacgtcagaaaccattattgcgcgttcaaaagtcgcctaaggtcactatcagctagcaaatatttcttgtcaaaaatgctccactgacgttccataaattcccctcggtatccaattagagtctcatattcactctcaatccagatctcgactctagtcgagggcccatgggagcttggattgaacaagatggattgcacgcaggttctccggccgcttgggtggagaggctattcggctatgactgggcacaacagacaatcggctgctctgatgccgccgtgttccggctgtcagcgcaggggcgcccggttctttttgtcaagaccgacctgtccggtgccctgaatgaactgcaggacgaggcagcgcggctatcgtggctggccacgacgggcgttccttgcgcagctgtgctcgacgttgtcactgaagcgggaagggactggctgctattgggcgaagtgccggggcaggatctcctgtcatctcaccttgctcctgccgagaaagtatccatcatggctgatgcaatgcggcggctgcatacgcttgatccggctacctgcccattcgaccaccaagcgaaacatcgcatcgagcgagcacgtactcggatggaagccggtcttgtcgatcaggatgatctggacgaagagcatcaggggctcgcgccagccgaactgttcgccaggctcaaggcgcgcatgcccgacggcgaggatctcgtcgtgacccatggcgatgcctgcttgccgaatatcatggtggaaaatggccgcttttctggattcatcgactgtggccggctgggtgtggcggaccgctatcaggacatagcgttggctacccgtgatattgctgaagagcttggcggcgaatgggctgaccgcttcctcgtgctttacggtatcgccgctcccgattcgcagcgcatcgccttctatcgccttcttgacgagttcttctgagcgggacccaagctagcttcgacggatcccccgatgagctaagctagctatatcatcaatttatgtattacacataatatcgcactcagtctttcatctacggcaatgtaccagctgatataatcagttattgaaatatttctgaatttaaacttgcatcaataaatttatgtttttgcttggactataatacctgacttgttattttatcaataaatatttaaactatatttctttcaagatgggaattaattcactggccgtcgttttacaacgtcgtgactgggaaaaccctggcgttacccaacttaatcgccttgcagcacatccccctttcgccagctggcgtaatagcgaagaggcccgcaccgatcgcccttcccaacagttgcgcagcctgaatggcgcccgctcctttcgctttcttcccttcctttctcgccacgttcgccggctttccccgtcaagctctaaatcgggggctccctttagggttccgatttagtgctttacggcacctcgaccccaaaaaacttgatttgggtgatggttcacgtagtgggccatcgccctgatagacggtttttcgccctttgacgttggagtccacgttctttaatagtggactcttgttccaaactggaacaacactcaaccctatctcgggctattcttttgatttataagggattttgccgatttcggaaccaccatcaaacaggattttcgcctgctggggcaaaccagcgtggaccgcttgctgcaactctctcagggccaggcggtgaagggcaatcagctgttgcccgtctcactggtgaaaagaaaaaccaccccagtacattaaaaacgtccgcaatgtgttattaagttgtctaagcgtcaatttgtttacaccacaatatatcctgccaccagccagccaacagctccccgaccggcagctcggcacaaaatcaccactcgatacaggcagcccatcagtccgggacggcgtcagcgggagagccgttgtaaggcggcagactttgctcatgttaccgatgctattcggaagaacggcaactaagctgccgggtttgaaacacggatgatctcgcggagggtagcatgttgattgtaacgatgacagagcgttgctgcctgtgatcaaatatcatctccctcgcagagatccgaattatcagccttcttattcatttctcgcttaaccgtgacaggctgtcgatcttgagaactatgccgacataataggaaatcgctggataaagccgctgaggaagctgagtggcgctatttctttagaagtgaacgttgacgatatcaactcccctatccattgctcaccgaatggtacaggtcggggacccgaagttccgactgtcggcctgatgcatccccggctgatcgaccccagatctagatctggggctgagaaagcccagtaaggaaacaactgtaggttcgagtcgcgagatcccccggaaccaaaggaagtaggttaaacccgctccgatcaggccgagccacgccaggccgagaacattggttcctgtaggcatcgggattggcggatcaaacactaaagctactggaacgagcagaagtcctccggccgccagttgccaggcggtaaaggtgagcagaggcacgggaggttgccacttgcgggtcagcacggttccgaacgccatggaaaccgcccccgccaggcccgctgcgacgccgacaggatctagcgctgcgtttggtgtcaacaccaacagcgccacgcccgcagttccgcaaatagcccccaggaccgccatcaatcgtatcgggctacctagcagagcggcagagatgaacacgaccatcagcggctgcacagcgcctaccgtcgccgcgaccccgcccggcaggcggtagaccgaaataaacaacaagctccagaatagcgaaatattaagtgcgccgaggatgaagatgcgcatccaccagattcccgttggaatctgtcggacgatcatcacgagcaataaacccgccggcaacgcccgcagcagcataccggcgacccctcggcctcgctgttcgggctccacgaaaacgccggacagatgcgccttgtgagcgtccttggggccgtcctcctgtttgaagaccgacagcccaatgatctcgccgtcgatgtaggcgccgaatgccacggcatctcgcaaccgttcagcgaacgcctccatgggctttttctcctcgtgctcgtaaacggacccgaacatctctggagctttcttcagggccgacaatcggatctcgcggaaatcctgcacgtcggccgctccaagccgtcgaatctgagccttaatcacaattgtcaattttaatcctctgtttatcggcagttcgtagagcgcgccgtgcgtcccgagcgatactgagcgaagcaagtgcgtcgagcagtgcccgcttgttcctgaaatgccagtaaagcgctggctgctgaacccccagccggaactgaccccacaaggccctagcgtttgcaatgcaccaggtcatcattgacccaggcgtgttccaccaggccgctgcctcgcaactcttcgcaggcttcgccgacctgctcgcgccacttcttcacgcgggtggaatccgatccgcacatgaggcggaaggtttccagcttgagcgggtacggctcccggtgcgagctgaaatagtcgaacatccgtcgggccgtcggcgacagcttgcggtacttctcccatatgaatttcgtgtagtggtcgccagcaaacagcacgacgatttcctcgtcgatcaggacctggcaacgggacgttttcttgccacggtccaggacgcggaagcggtgcagcagcgacaccgattccaggtgcccaacgcggtcggacgtgaagcccatcgccgtcgcctgtaggcgcgacaggcattcctcggccttcgtgtaataccggccattgatcgaccagcccaggtcctggcaaagctcgtagaacgtgaaggtgatcggctcgccgataggggtgcgcttcgcgtactccaacacctgctgccacaccagttcgtcatcgtcggcccgcagctcgacgccggtgtaggtgatcttcacgtccttgttgacgtggaaaatgaccttgttttgcagcgcctcgcgcgggattttcttgttgcgcgtggtgaacagggcagagcgggccgtgtcgtttggcatcgctcgcatcgtgtccggccacggcgcaatatcgaacaaggaaagctgcatttccttgatctgctgcttcgtgtgtttcagcaacgcggcctgcttggcctcgctgacctgttttgccaggtcctcgccggcggtttttcgcttcttggtcgtcatagttcctcgcgtgtcgatggtcatcgacttcgccaaacctgccgcctcctgttcgagacgacgcgaacgctccacggcggccgatggcgcgggcagggcagggggagccagttgcacgctgtcgcgctcgatcttggccgtagcttgctggaccatcgagccgacggactggaaggtttcgcggggcgcacgcatgacggtgcggcttgcgatggtttcggcatcctcggcggaaaaccccgcgtcgatcagttcttgcctgtatgccttccggtcaaacgtccgattcattcaccctccttgcgggattgccccgactcacgccggggcaatgtgcccttattcctgatttgacccgcctggtgccttggtgtccagataatccaccttatcggcaatgaagtcggtcccgtagaccgtctggccgtccttctcgtacttggtattccgaatcttgccctgcacgaataccagcgaccccttgcccaaatacttgccgtgggcctcggcctgagagccaaaacacttgatgcggaagaagtcggtgcgctcctgcttgtcgccggcatcgttgcgccacatctaggtactaaaacaattcatccagtaaaatataatattttattttctcccaatcaggcttgatccccagtaagtcaaaaaatagctcgacatactgttcttccccgatatcctccctgatcgaccggacgcagaaggcaatgtcataccacttgtccgccctgccgcttctcccaagatcaataaagccacttactttgccatctttcacaaagatgttgctgtctcccaggtcgccgtgggaaaagacaagttcctcttcgggcttttccgtctttaaaaaatcatacagctcgcgcggatctttaaatggagtgtcttcttcccagttttcgcaatccacatcggccagatcgttattcagtaagtaatccaattcggctaagcggctgtctaagctattcgtatagggacaatccgatatgtcgatggagtgaaagagcctgatgcactccgcatacagctcgataatcttttcagggctttgttcatcttcatactcttccgagcaaaggacgccatcggcctcactcatgagcagattgctccagccatcatgccgttcaaagtgcaggacctttggaacaggcagctttccttccagccatagcatcatgtccttttcccgttccacatcataggtggtccctttataccggctgtccgtcatttttaaatataggttttcattttctcccaccagcttatataccttagcaggagacattccttccgtatcttttacgcagcggtatttttcgatcagttttttcaattccggtgatattctcattttagccatttattatttccttcctcttttctacagtatttaaagataccccaagaagctaattataacaagacgaactccaattcactgttccttgcattctaaaaccttaaataccagaaaacagctttttcaaagttgttttcaaagttggcgtataacatagtatcgacggagccgattttgaaaccacaattatgggtgatgctgccaacttactgatttagtgtatgatggtgtttttgaggtgctccagtggcttctgtgtctatcagctgtccctcctgttcagctactgacggggtggtgcgtaacggcaaaagcaccgccggacatcagcgctatctctgctctcactgccgtaaaacatggcaactgcagttcacttacaccgcttctcaacccggtacgcaccagaaaatcattgatatggccatgaatggcgttggatgccgggcaacagcccgcattatgggcgttggcctcaacacgattttacgtcacttaaaaaactcaggccgcagtcggtaacctcgcgcatacagccgggcagtgacgtcatcgtctgcgcggaaatggacgaacagtggggctatgtcggggctaaatcgcgccagcgctggctgttttacgcgtatgacagtctccggaagacggttgttgcgcacgtattcggtgaacgcactatggcgacgctggggcgtcttatgagcctgctgtcaccctttgacgtggtgatatggatgacggatggctggccgctgtatgaatcccgcctgaagggaaagctgcacgtaatcagcaagcgatatacgcagcgaattgagcggcataacctgaatctgaggcagcacctggcacggctgggacggaagtcgctgtcgttctcaaaatcggtggagctgcatgacaaagtcatcgggcattatctgaacataaaacactatcaataagttggagtcattacccaattatgatagaatttacaagctataaggttattgtcctgggtttcaagcattagtccatgcaagtttttatgctttgcccattctatagatatattgataagcgcgctgcctatgccttgccccctgaaatccttacatacggcgatatcttctatataaaagatatattatcttatcagtattgtcaatatattcaaggcaatctgcctcctcatcctcttcatcctcttcgtcttggtagctttttaaatatggcgcttcatagagtaattctgtaaaggtccaattctcgttttcatacctcggtataatcttacctatcacctcaaatggttcgctgggtttatcgcacccccgaacacgagcacggcacccgcgaccactatgccaagaatgcccaaggtaaaaattgccggccccgccatgaagtccgtgaatgccccgacggccgaagtgaagggcaggccgccacccaggccgccgccctcactgcccggcacctggtcgctgaatgtcgatgccagcacctgcggcacgtcaatgcttccgggcgtcgcgctcgggctgatcgcccatcccgttactgccccgatcccggcaatggcaaggactgccagcgctgccatttttggggtgaggccgttcgcggccgaggggcgcagcccctggggggatgggaggcccgcgttagcg